(19) United States
(12) Patent Application Publication
(10) Pub. No.: US 2008/0159216 A1
(43) Pub. Date: Jul. 3, 2008

(54) Method, Apparatus, Communications System, Computer Program, Computer Program Product and Module

(76) Inventors: Harri Holma, Helsinki (FI); Martin Kristensson, Helsinki (FI)

Correspondence Address: Hollingsworth & Funk, LLC, Suite 125, 8009 34th Avenue South, Minneapolis, MN, 55425, US

(21) Appl. No.: 11/961,027

(22) Filed: Dec. 20, 2007

(30) Foreign Application Priority Data
Dec. 27, 2006 (FI) 20065858

(51) Int. Cl. H04Q 7/00

(52) U.S. Cl. 370/329

(57) ABSTRACT

The invention relates to an apparatus that receives a request for a radio connection and checks at least one of: subscriber information, a service request and terminal information. On the basis of the at least one of: subscriber information, service request and terminal information, the apparatus directs data to be delivered via the requested radio connection to different network elements of the communications system.

The invention relates to a data processing method, an apparatus, a communications system, a computer program, a computer program product and a module.

High Speed Packet Access, HSPA, is able to provide high data rate transmission to support multimedia services. HSPA brings high-speed data delivery to 3rd generation (3G) terminals. HSPA includes High Speed Downlink Packet Access (HSDPA) and High Speed Uplink Packet Access (HSUPA).

In the Wideband Code Division Multiple Access (WCDMA) concept, HSDPA implementations usually include Adaptive Modulation and Coding (AMC) functionality, a shorter frame size (2 ms), Hybrid Automatic Repeat Request (HARQ) functionality and fast Node-B based packet scheduling. HSUPA includes a shorter frame size, HARQ functionality and fast Node-B based scheduling as well.

Internet-HSPA, in other words Internet High Speed Packet Access (I-HSPA) refers to a concept that uses the 3rd Generation Partnership Project (3GPP) HSPA air interface standard, but I-HSPA uses a simpler network architecture that is flatter than the architecture originally outlined in 3GPP. I-HSPA architecture may utilize a gateway general packet radio service (GPRS) support node (GGSN) using a GPRS tunnelling protocol (GTP) or Mobile Internet Protocol with a home agent. One, and perhaps the main, difference between I-HSPA and the standard architecture outlined in 3GPP is that, in I-HSPA, the radio network controller (RNC) functionalities are typically located in an I-HSPA unit in the Node B.

In this application, the term HSPA means an architecture that carries HSPA connections, traditional circuit switched bearers and packet switched bearers. The term I-HSPA means architecture that supports data bearers only.

I-HSPA carriers are primarily designed to carry HSPA packet data bearers only; i.e., traditional circuit switched and packet switched bearers over dedicated bearers (data channels) are not supported. One problem with having data dedicated carriers is that legacy terminals using circuit switched connections for carrying voice calls cannot use I-HSPA carriers. Hence, in cases where data traffic does not fill up a whole I-HSPA carrier, the I-HSPA carrier is partially empty, for the system is not able to allocate terminals that require circuit switched connections to the I-HSPA carrier. This may result in sub-optimal hardware utilization when introducing I-HSPA in networks where a remarkable part of the traffic is circuit switched voice or carried over dedicated data bearers.

### BRIEF DESCRIPTION OF THE INVENTION

In an embodiment, terminals that utilize both circuit switched and dedicated data bearers are connected via an I-HSPA carrier to an I-HSPA base station. Traffic is routed from an I-HSPA base station via a radio network controller (RNC) to a core network. Between a radio network controller and a core network, circuit switched bearers and dedicated data bearers are handled in a similar manner to that of the traditional network architecture both in the circuit and packet switched domains.

According to an aspect of the invention, there is provided a data processing method in a communication system, the method comprising: receiving a request for a radio connection; checking subscriber information, a service request and/or terminal information; and directing, on the basis of the subscriber information, service request and/or terminal information, data to be delivered via the requested radio connection to different network elements of the communications system.

According to another aspect of the invention, there is provided an apparatus configured to: receive a request for a radio connection; check subscriber information, a service request and/or terminal information; and direct, on the basis of the subscriber information, service request and/or terminal information, data to be delivered via the requested radio connection to different network elements of the communications system.

According to another aspect of the invention, there is provided a communication system, being configured to: receive a request for a radio connection; check subscriber information, a service request and/or terminal information; and direct, on the basis of the subscriber information, service request and/or terminal information, data to be delivered via the requested radio connection to different network elements of the communications system.

According to another aspect of the invention, there is provided a computer program product encoding a computer program of instructions for executing a computer process for data processing, the process comprising: receiving a request for a radio connection checking subscriber information, a service request and/or terminal information; and directing, on the basis of the subscriber information, service request and/or terminal information, data to be delivered via the requested radio connection to different network elements of the communications system.

According to another aspect of the invention, there is provided a computer program distribution medium readable by a computer and encoding a computer program of instructions for executing a computer process for data processing, the process comprising: receiving a request for a radio connection; checking subscriber information, a service request and/or terminal information; and directing, on the basis of the subscriber information, service request and/or terminal information, data to be delivered via the requested radio connection to different network elements of the communications system.

According to another aspect of the invention, there is provided a module being configured to organize in user plane multiplexing data to be delivered to radio access bearers on the basis of priority parameters.

According to another aspect of the invention, there is provided an apparatus, comprising: means for receiving a request for a radio connection; means for checking subscriber information, a service request and/or terminal information; and means for directing, on the basis of the subscriber information, service request and/or terminal information, data to be delivered via the requested radio connection to different network elements of the communications system.

An embodiment of the invention provides a possibility of controlling several kinds of transmissions, typically HSPA and I-HSPA transmissions, in the same network and even on the same carrier. Resources can be used more economically and delays can be diminished, because no dedicated I-HSPA carriers are needed; carriers may also be shared with normal calls: if there are not enough packet data available, carriers may be filled with speech.

### LIST OF DRAWINGS

In the following, the invention will be described in greater detail with reference to the embodiments and the accompanying drawings, in which

FIG. 1 shows an example of a communications system;

FIG. 2 is a flow chart;

FIG. 3 illustrates an example of a network element;

FIG. 4 illustrates another example of a network element; and

FIG. 5 illustrates another example of a network element.

### DESCRIPTION OF EMBODIMENTS

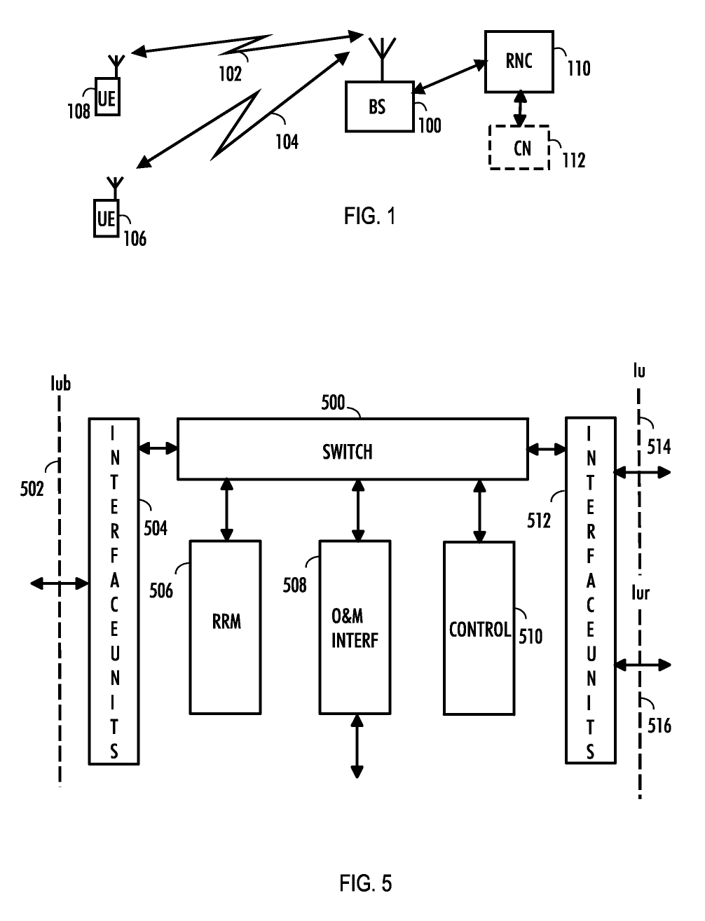

With reference to FIG. 1, we examine an example of a communications system to which embodiments of the invention can be applied. The present invention can be applied to communication systems offering HSPA services. One example of such a communication system is the Universal Mobile Telecommunications System (UMTS) radio access network (UTRAN). It is a radio access network which includes Wideband Code Division Multiple Access (WCDMA) technology and can also offer real-time circuit and packet switched services. The embodiments are not, however, restricted to the systems given as examples but a person skilled in the art may apply the solution to other communication systems provided with the necessary properties.

FIG. 1 is a simplified illustration of a data transmission system (a communications system) to which embodiments according to the invention are applicable. This is a part of a cellular radio system which comprises a base station (or node B) 100, which has bidirectional radio links 102 and 104 to user devices 106 and 108. The user devices may be fixed, vehicle-mounted or portable. The base station includes transceivers, for instance. From the transceivers of the base station, a connection is provided to an antenna unit that establishes bi-directional radio links to the user devices. The base station is further connected to a controller 110, a radio network controller (RNC), which transmits the connections of the devices to the other parts of the network. The radio network controller controls in a centralized manner several base stations connected to it. The radio network controller is further connected to a core network 112 (CN). Depending on the system, the counterpart on the CN side can be a mobile services switching centre (MSC), a media gateway (MGW) or a serving GPRS (general packet radio service) support node (SGSN), etc.

It should be noticed that in future radio networks, the functionality of an RNC may be distributed among (possibly a subset of) base stations.

The communication system is also able to communicate with other networks, such as a public switched telephone network or the Internet.

High Speed Packet Access (HSPA) is designed to improve communications network capacity and increase user data rates in the air interface. The main target is to provide higher data rates, a lower latency as well as higher cell capacity.

The scheduling of the transmission of data packets for the air interface may be carried out in HSPA located in a base station (or RNC), since the base station is the network element which is closest to the air interface. However, in conventional WCDMA systems (conventional meaning systems before HSPA technology introduction), packet scheduling is typically located in a radio network controller.

HSPA packet scheduling is usually based on information about channel quality, user terminal capability, quality of service (QoS) class and power and/or code availability.

In a WCDMA system, user data is normally carried using Dedicated Transport Channels (DCH). Typically, several dedicated transport channels are code multiplexed onto one radio frequency carrier or bearer.

HSPA transmissions normally use a High Speed Downlink Shared Channel (HS-DSCH) that is designed for delivering bursty packet data. HS-DSCH channels share multiple access codes and transmission power between several users. This enables time multiplexing of several users to a common transport channel. HSUPA transmissions typically use an Enhanced-DCH in uplink with fast sharing of the uplink resources between users.

An embodiment of a data processing method in a communications system provides functionality in an I-HSPA base station to detect the terminal capabilities and requests, and then, based on this information, the I-HSPA base station routes a connection in question either via an I-HSPA core network or via a radio network controller to core network elements.

The embodiment also includes necessary control functions, such as admission control and load control, to ensure that the traditional bearers have enough air interface and transport resources in the I-HSPA base station, radio network controller and core network.

The I-HSPA base station is also capable of adjusting a packet scheduling algorithm when it allocates new traditional bearers: in some cases, air interface resources over the shared HSPA channel are decreased in order to find space for traditional data and circuit switched bearers.

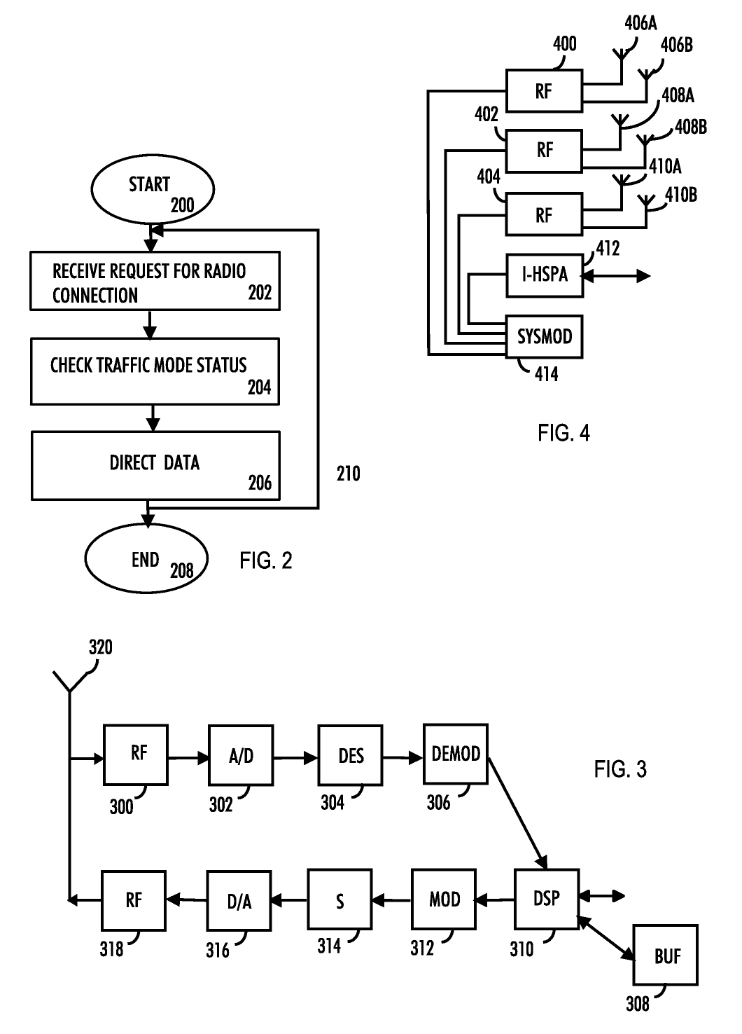

In the following, an embodiment of a data processing method in a communications system is explained in further detail by means of FIG. 2. The embodiment provides a possibility of controlling several kinds of transmissions, typically HSPA and I-HSPA transmissions, in the same network and even allocating a same carrier to HSPA and I-HSPA transmissions.

In this application, a carrier refers to a whole frequency block (typically 5 MHz) and a bearer refers to a single user connection (RAB=radio access bearer or RB=radio bearer).

It should be noticed that in an embodiment different network elements are technically different elements carrying out different functions and not only different physical elements each carrying out same functions.

The embodiment begins in block 200.

In block 202, a request for a radio connection is received. The radio connection request is usually transmitted by a user terminal to the network element controlling the communications network. The request may be a prior art Radio Resource Control (RRC) request. In the UMTS communications systems, Radio Resource Control is a sub-layer of radio interface layer 3 which exists in the control plane and provides information transfer. Radio Resource Control (RRC) is responsible for controlling the configuration of radio interface layers 1 and 2.

A Radio Resource Control connection is a point-to-point bi-directional connection between a user terminal and a radio access network (RAN).

In block 204, subscriber information and a service request are checked. The check is typically based on the radio connection request, in which case the radio connection request contains information on the nature of a transmission to be delivered, for example, whether the transmission is an HSPA or I-HSPA transmission.

An RRC request contains user terminal identity information, such as an International Mobile Subscriber Identity (IMSI), Temporary Mobile Sub-scriber Identity (TMSI), Packet Temporary Mobile Subscriber Identity (P-TMSI) and/or International Mobile Equipment Identity (IMEI).

IMSI is a unique subscription identifier consisting of the National Mobile Subscriber Identity (NMSI) and the Mobile Country Code (MCC). IMEI is an identity with which a user terminal can be uniquely identified. Usually IMEI is the serial number of the user terminal.

It should be noticed that the status may also be an emergency call, in which case the call is processed similarly to prior art emergency calls.

In block 206, data to be delivered via the requested radio connection is directed on the basis of the subscriber information and service request to different network elements of the communications system.

There are many options for implementing the checking of subscriber information and a service request and directing data. There may be a separate unit including necessary software and/or hardware to check the subscriber information and/or service request of a transmission and/or to direct the transmission to the right network unit, for instance. If the transmission is an I-HSPA transmission, in a UMTS network, it is processed by an I-HSPA unit and then directed to an Integrated Services Network (ISN) unit for conveyance to the Internet, or if it is an ordinary HSDPA transmission, it is directed to a Radio Network Controller (RNC). Simplifying, it can be said that HSPA transmissions are directed to a Radio Network Controller (RNC), whereas I-HSPA transmissions are processed in the I-HSPA unit.

The process may also be carried out by using software which is a part of a larger software packet. Time saving will be achieved, if the checking and directing are carried out in a base station (or a node B) or a corresponding unit which is the nearest network element to the air interface.

The embodiment ends in block 208. The embodiment is typically repeated for each data packet and/or speech data as long as radio connection requests are received. One possibility of repeating the embodiment is shown by arrow 210.

Additionally, for transmission power control or, in other words, power control of the communications system, information on power used for I-HSPA transmissions may be sent to a Radio Network Controller.

Further, user plane multiplexing may be carried out in the same unit taking care of checking subscriber information and service request and directing data. A separate unit for multiplexing may also be designed. When both HSPA and I-HSPA transmissions are present and resources are wished to be used efficiently, a single HSPA data channel, HS-DSCH (High Speed Downlink Shared Channel), may be shared by two user plane flows: one from a Radio Network Controller (HSPA transmissions) and another from a base station (I-HSPA transmissions).

In the user plane multiplexing, organizing data or packets for radio access bearers may be carried out on the basis of priority parameters. A plurality of parameters may be used, such as an order of arrival and Quality of service priority. I-HSPA transmissions may have a lower, similar or higher priority than the one of HSPA transmissions. Similarly, uplink power resources for HSUPA can be shared between WCDMA/HSPA and I-HSPA.

Next, an example of a network element will be described by means of FIG. 3. The network element is an example of an apparatus being able to carry out embodiments of the data processing method (and/or user plane multiplexing).

FIG. 3 illustrates a simplified exemplary embodiment of a network element in relation to the functionalities required by the data processing method described above. It is obvious to a person skilled in the art that the network element can deviate from what is depicted in FIG. 3, for instance according to a modulation method used. The network element illustrated in FIG. 3 is a base station (or node B). For the sake of clarity, the network element is depicted as an element of a single carrier system. It is obvious for a person skilled in the art that the system may also be a multicarrier system.

In FIG. 3, blocks 312 to 318 describe a transmitter and blocks 300 to 306 a receiver. The example of FIG. 3 shows the radio parts of the transmitter and the receiver as separate, but they may also be combined. A signal-processing block 310 describes the hardware parts of the base station required to generate user speech or data in the transmitter. There may be one signal processing block, such as in the example of the figure, or a separate one for the transmitter and the receiver.

Signal processing, which includes channel coding, for example, is usually implemented in a DSP processor 310 (DSP=Digital Signal Processing). The aim of channel coding is to make sure that the information transmitted can be restored in the receiver, although not every information bit could be received properly.

In a block 312, the signal is modulated using the desired modulation method. Block 314 describes multiplication by a spreading code performed on the information to be transmitted in direct sequence spread spectrum systems and used to spread a narrowband signal into wideband. Modulation and spreading may also be a part of the DSP processor.

The signal is converted from digital into analog form in a block 316. In RF parts 318, the signal is up-converted to the selected transmission frequency either directly or via an intermediate frequency, amplified, and filtered, if necessary.

In the example of the figure, the transmitter and the receiver share the same antenna 320, whereby a duplex filter is required to separate a signal to be transmitted and a signal to be received from each other. The antenna may be an individual antenna or an array antenna composed of several antenna elements.

The receiver comprises RF parts 300, where a received signal is filtered, down-converted either directly to a base band or to an intermediate frequency, and amplified. In a block 302, the signal is converted from analog into digital by sampling and quantizing; in a block 304, the direct spread wideband signal is despread by multiplication by a code sequence generated by a code generator; in a block 306, the effect of the data modulation is removed by demodulation; and, in a block 310, necessary signal processing is performed, such as de-interleaving, decoding and decryption.

Block 308 is a buffer memory, where radio connection requests can be stored.

The precise implementation of the base station (node B) is vendor-dependent.

In this example, checking subscriber information, a service request and/or terminal information and directing data to be delivered via the requested radio connection to different network elements of the communications system are carried out in DSP block 310. Requests for a radio connection are received in a similar manner to prior art.

Additionally, for transmission power control or, in the other words, power control of the communications system, information on power used to I-HSPA transmissions may be sent to a Radio Network Controller as a part of a normal signalling transmission.

The disclosed functionalities of the embodiments of the invention can be advantageously implemented by means of software in appropriate parts of a network element, such as a DSP processor. Other implementation solutions are also possible, such as different hardware implementations (modules), e.g. a circuit built of separate logics components or one or more client-specific integrated circuits (Application-Specific Integrated Circuit, ASIC). A hybrid of these implementations is also feasible.

Another option for implementing embodiments of the data processing method is a separate device comprising requested software and hardware.

Embodiments of the data processing method and user plane multiplexing may be placed in the same unit or in separate units. The unit carrying out a data processing method may be thought to be some kind of an adapter (see FIG. 4) and the unit carrying out user plane multiplexing, a scheduler or a part of it. An HSDPA scheduler may be a part of base station functionality.

Another exemplary embodiment of a base station is depicted in FIG. 4.

The base station includes a plurality of radio frequency modules 400, 402, 404 carrying out radio frequency functions of both a receiver and a transmitter, such as digital-to-analog conversion, analog-to-digital conversion and power amplifying. The radio frequency modules are connected to antennas 406A-B, 408A-B, 410A-B.

The base station also includes an Internet-HSPA adapter 412 checking subscriber information, a service request and/or terminal information and directing data to be delivered via the requested radio connection to different network elements of the communications system. The Internet-HSPA adapter may be connected via a Gi interface to the Internet, via an lu interface to SGSN or a Gn interface to GGSN. The physical transport may be Ethernet, microwave radio or lease E1/T1 connections.

Requests for a radio connection are typically received in a similar manner to prior art.

The base station also includes a system module 414 carrying out baseband processing and system control functions, such as Rake receiver signal combining, spreading/despreading, encoding/decoding and application managing. The system module may also be integrated into one or more radio frequency modules.

Further, the base station may include an Internet-HSPA transmission module for carrying out data transmissions to the Internet or the transmissions to the Internet may be carried out by the Internet-HSPA adapter.

Additionally, for transmission power control or, in other words, power control of the communications system, information on power used for I-HSPA transmissions may be sent to a Radio Network Controller as a part of a normal signalling transmission.

The disclosed functionalities of the embodiments of the invention can be advantageously implemented by means of software in appropriate parts of a network element, such as a DSP processor. Other implementation solutions are also possible, such as different hardware implementations (modules), e.g. a circuit built of separate logics components or one or more client-specific integrated circuits (Application-Specific Integrated Circuit, ASIC). A hybrid of these implementations is also feasible.

The embodiments of the data processing method can mainly be implemented by software (a computer program) storable in an appropriate part of a network element, module or device including instructions for executing a computer process for checking a subscriber information and a service request of the requested radio connection and directing, on the basis of the subscriber information, service request and/or terminal information, data to be delivered via the requested radio connection to different network elements of the communications system.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Referring to FIG. 5, a simplified block diagram illustrates an example of a radio network controller's (RNC) logical structure. RNC is an example of an apparatus being able to carry out embodiments of the data processing method (and/or user plane multiplexing).

RNC is the switching and controlling element of UTRAN. The switching 500 takes care of connections between the core network and the user terminal. The radio network controller is located between Iub 502 and Iu 514 interfaces. The network controller in connected to these interfaces via interface units 504, 512. There is also an interface for inter-RNC transmission, called Iur 516.

The functionality of the radio network controller can be classified into two classes: UTRAN radio resource management 506 and control functions 510. An operation and management interface function 508 serves as a medium for information transfer to and from network management functions.

The radio resource management is a group of algorithms for sharing and managing the radio path connection so that the quality and capacity of the connection are adequate. The most important radio resource management algorithms are handover control, power control, admission control, packet scheduling, and code management. According to an embodiment of the data processing method, information on power used for I-HSDPA transmissions is sent to the Radio Network Controller which is in charge of power control in the communications system.

The UTRAN control functions take care of functions related to the set-up, maintenance and release of a radio connection between the base stations and user terminals.

The precise implementation of the radio network controller (RNC) is vendor-dependent.

Embodiments of the data processing method may also be implemented in a network element which carries out the tasks of both a base station and a radio network controller.

Even though the invention is described above with reference to an example according to the accompanying drawings, it is clear that the invention is not restricted thereto but it can be modified in several ways within the scope of the appended claims.

1. A method comprising:
receiving a request for a radio connection;
checking at least one of: subscriber information, a service request and terminal information; and
directing, on the basis of at least one of: the subscriber information, service request and terminal information, data to be delivered via the requested radio connection to different network elements of a communications system.

2. The method of claim 1, further comprising: organizing in user plane multiplexing data to be delivered to radio access bearers on the basis of priority parameters.

3. The method of claim 1, further comprising: organizing in user plane multiplexing data to be delivered to radio access bearers on the basis of at least one of the following parameters: an order of arrival and Quality of service priority.

4. The method of claim 1, wherein the request is a Radio Resource Control request.

5. The method of claim 1, wherein the subscriber information, service request and terminal information checking is based on information on whether the transmission is a High Speed Packet Access or Internet High Speed Packet Access transmission.

6. The method of claim 1, further comprising: directing Internet High Speed Packet Access transmissions to an Integrated Services Network unit for conveyance to the Internet and High Speed Packet Access transmissions to a Radio Access Network.

7. The method of claim 1, further comprising: sending information on power used for Internet High Speed Packet Access transmissions to a Radio Network Controller for power control of the communications system.

8. An apparatus configured to:
receive a request for a radio connection;
check at least one of: subscriber information, a service request and terminal information; and
direct, on the basis of at least one of: the subscriber information, service request and terminal information, data to be delivered via the requested radio connection to different network elements of a communications system.

9. The apparatus of claim 8, further configured to organize in user plane multiplexing data to be delivered to radio access bearers on the basis of priority parameters.

10. The apparatus of claim 8, further configured to organize in user plane multiplexing data to be delivered to radio access bearers on the basis of at least one of the following parameters: an order of arrival and Quality of service priority.

11. The apparatus of claim 8, wherein the request is a Radio Resource Control request.

12. The apparatus of claim 8, wherein the subscriber information, service request and terminal information check is based on information on whether the transmission is a High Speed Packet Access or Internet High Speed Packet Access transmission.

13. The apparatus of claim 8, further configured to direct Internet High Speed Packet Access transmissions to an Integrated Services Network unit for conveyance to the Internet and High Speed Packet Access transmissions to Radio Access Network.

14. The apparatus of claim 8, further configured to send information on power used for Internet High Speed Packet Access transmissions to a Radio Network Controller for power control of the communications system.

15. The apparatus of claim 8, wherein the apparatus is a network element.

16. The apparatus of claim 8, wherein the apparatus is a module.

17. A communication system, configured to:
receive a request for a radio connection;
check at least one of: subscriber information, a service request and terminal information; and
direct, on the basis of at least one of: the subscriber information, service request and terminal information, data to be delivered via the requested radio connection to different network elements of a communications system.

18. The communication system of claim 17, further configured to organize in user plane multiplexing data to be delivered to radio access bearers on the basis of priority parameters.

19. The communication system of claim 17, further configured to organize in user plane multiplexing data to be delivered to radio access bearers on the basis of at least one of the following parameters: an order of arrival and Quality of service priority.

20. The communication system of claim 17, wherein the request is a Radio Resource Control request.

21. The communication system of claim 17, wherein the subscriber information, service request and terminal information check is based on information on whether the transmission is a High Speed Packet Access or Internet High Speed Packet Access transmission.

22. The communication system of claim 17, further configured to direct Internet High Speed Packet Access transmissions to an Integrated Services Network unit for conveyance to the Internet and High Speed Packet Access transmissions to a Radio Access Network.

23. The communication system of claim 17, further configured to send information on power used for Internet High Speed Packet Access transmissions to a Radio Network Controller for power control of the communications system.

24. A computer program product encoding a computer program of instructions for executing a computer process for data processing, the process comprising:
receiving a request for a radio connection;
checking at least one of: subscriber information, a service request and terminal information; and
directing, on the basis of at least one of: the subscriber information, service request and terminal information, data to be delivered via the requested radio connection to different network elements of a communications system.

25. A computer program distribution medium readable by a computer and encoding a computer program of instructions for executing a computer process for data processing, the process comprising:
receiving a request for a radio connection;
checking at least one of: subscriber information, a service request and terminal information; and
directing, on the basis of at least one of: the subscriber information, service request and terminal information, data to be delivered via the requested radio connection to different network elements of a communications system.

26. The computer program distribution medium of claim 25, the distribution medium including at least one of the following mediums: a computer readable medium, a program storage medium, a record medium, a computer readable memory, a computer readable software distribution package, a
computer readable signal, a computer readable telecommunications signal, and a computer readable compressed software package.

27. A module configured to:
organize in user plane multiplexing data to be delivered to radio access bearers on the basis of priority parameters.

28. An apparatus, comprising:
means for receiving a request for a radio connection;
means for checking at least one of: subscriber information, a service request and terminal information; and
means for directing, on the basis of at least one of: the subscriber information, service request and terminal information, data to be delivered via the requested radio connection to different network elements of a communications system.

29. The apparatus of claim 28, further comprising means for organizing in user plane multiplexing data to be delivered to radio access bearers on the basis of priority parameters.

30. The apparatus of claim 28, further comprising means for organizing in user plane multiplexing data to be delivered to radio access bearers on the basis of at least one of the following parameters: an order of arrival and Quality of service priority.

31. The apparatus of claim 28, wherein the request is a Radio Resource Control request.

32. The apparatus of claim 28, wherein the subscriber information, service request and terminal information check is based on information on whether the transmission is a High Speed Packet Access or Internet High Speed Packet Access transmission.

33. The apparatus of claim 28, wherein the means for directing direct Internet High Speed Packet Access transmissions to an Integrated Services Network unit for conveyance to the Internet and High Speed Packet Access transmissions to Radio Access Network.

34. The apparatus of claim 28, wherein the means for directing send information on power used for Internet High Speed Packet Access transmissions to a Radio Network Controller for power control of the communications system.

35. The apparatus of claim 28, wherein the apparatus is a network element.

36. The apparatus of claim 28, wherein the apparatus is a module.
